(19) United States
(12) Patent Application Publication
(10) Pub. No.: US 2004/0129177 A1
(43) Pub. Date: Jul. 8, 2004

(54) Method and installation for the dehydroxylation treatment of aluminium silicate

(76) Inventor: Gael Cadoret, Paris (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/468,602

(22) PCT Filed: Feb. 6, 2002
(86) PCT No.: PCT/FR02/00456

(30) Foreign Application Priority Data
Feb. 20, 2001 (FR) 01/03094

(51) Int. Cl. C04B 14/04; B01J 8/00

(52) U.S. Cl. 106/486; 106/484; 422/198; 422/199; 422/190; 422/232

(57) ABSTRACT

The invention concerns a process and an installation for dehydroxylation treatment of aluminium silicate, in which particles containing aluminium silicate are exposed to a temperature of at least 500° C. The particles are in the form of a dry powder, and the dry powder (26) is optionally transported in a gas stream (30) at a temperature of from 600 to 850° C., for a time which is sufficient to achieve the desired degree of dehydroxylation. The powder may be obtained from a hydrated base paste by reducing the base paste into fragments (23), and by disaggregating the fragments (23) of base paste by mechanical action (at 3) in the presence of a hot gas (24) at a temperature of from 500° C. to 800° C., in order to form the dry powder (26).

The present invention relates to the treatment of mineral particles. It concerns more particularly a process for dehydroxylation treatment of aluminium silicate, which may in particular be contained in clays, in order to provide it with, or to enhance, its reactivity as an additive or addition (of the pouzzolanic type) in cement, concrete or other matrices.

It is known to add aluminium silicate in the form of metakaolin to cement, mortar or concrete compositions, as an additive capable of reacting with the lime released by hydration of the cement, in particular in cements reinforced with glass fibres where the lime released during ageing of the cement has a detrimental effect on the reinforcement properties.

This aluminium silicate in a reactive form can be obtained by a thermal calcination treatment of kaolin or kaolinite, generally from an argillaceous starting material. The endothermic reaction is as follows:

Al₂O₃.2SiO₂.2H₂O→Al₂O₃.2H₂+2H₂O (≈−418 joules/gram)

It takes place at a temperature of about 500 to 650° C., depending on the nature of the initial clay.

The industrial implementation of this treatment needs to satisfy two requirements: treating the argillaceous material thoroughly in order to convert all the kaolin into metakaolin, without the temperature of the treated material reaching the breakdown temperature of metakaolin, which may be converted (during an endothermic reaction) at about 900° C. into an unreactive crystallised form such as mullite or cristobalite.

In one known industrial technique, clay in the form of pellets is treated in a plate furnace, in which each stage heated by burners to a given temperature comprises a plate on which a substantial thickness of clay is deposited, and scraper arms which ensure that the clay is exposed to the temperature of the stage for the desired time and which direct the material treated on one plate to the next plate. Typically, these installations impose a temperature gradient which increases in the circulation direction of the clay, of the order of 500 to 750° C. at the plates. In order to achieve these temperatures, the burners heat walls locally to much higher temperatures, and the components of the furnace, in particular walls and arms, which are subjected to high stresses need to be made of refractory materials with good thermal stability and/or need to be provided with a cooling system. Furthermore, the residence time of the materials in the furnace is very long and entails very significant energy consumption and, lastly, the fine particles which are produced by attrition of the pellets are entrained by the firing gases, therefore necessitating a treatment to remove dust from the fumes.

In another known technique, which is referred to as “flash calcination”, clay particles are subjected to considerable temperature gradients, so as to reach the treatment temperature almost immediately. In practice, the clay particles are placed in an environment whose temperature may be as much as 900 to 1000° C., or more, for a very short time, so that the heat exchanges bring the particle to the desired temperature of the order of 500-600° C. According to certain embodiments, the calcination furnace comprises an enclosed space in which a burner that produces the desired temperature is installed. This type of furnace involves the risk that the particles may come into contact with the flame of the burner and exceed the desired treatment temperature. Another type of flash calcination furnace, described in particular in U.S. Pat. No. 6,139,313, comprises a chamber for treatment by a toroidal gas stream, in which a very high-temperature plasma is formed by injecting fuel into a hot gas stream created upstream of the treatment chamber. The critical components of the furnace are once more exposed to very high temperatures, which necessitates complicated cooling devices.

It is an object of the present invention to provide an improved process for treatment by calcination, which provides a satisfactory conversion yield without necessitating a complicated installation or expensive materials.

This object has been achieved according to the invention by a process for dehydroxylation treatment of aluminium silicate, in which particles containing aluminium silicate are exposed to a temperature of at least 500° C., characterised in that the particles are in the form of a dry powder, and in that the dry powder is transported in a gas stream at a temperature of from 600 to 850° C., for a time which is sufficient to achieve the desired degree of dehydroxylation.

The invention has revealed that the material containing aluminium silicate, when it is divided in a powdered form, reacts astonishingly rapidly in the transport gas, the temperature of which is nevertheless much less than the usual treatment temperatures of a “flash” calcination treatment, so that the invention provides a thermal dehydroxylation treatment which is inexpensive to implement in terms of both the energy required and the materials used to make the treatment devices.

To provide a specific reference, the dry powder generally has a particle size of less than or equal to 100 μm, i.e. all the particles which form it have a size characterised by dimensions (diameter or apparent diameter) of less than or equal to 100 μm. Preferably, it is essentially composed of particles with dimensions of less than or equal to 80 μm. It advantageously comprises at least 60% by weight of particles with a dimension of less than 20 μm, and preferably a small quantity (for example less than or equal to 5%) of particles with dimensions greater than 40 microns (95%<40 microns).

Advantageously, the powder is formed from a hydrated base paste containing aluminium silicate, in the following way: the base paste is reduced into fragments, and the fragments of base paste are disaggregated by mechanical action in the presence of a hot gas at a temperature of the order of 500° C. to 800° C.

According to the invention, it has also unexpectedly been found that a simple mechanical operation of grinding, milling, kneading or the like, carried out in the presence of a hot gas with a temperature of greater than or equal to 500° C., which would usually be envisaged for drying a hydrated material, makes it possible not only to evaporate the water of hydration of the base paste, but furthermore to initiate separation of the bound water of the aluminium silicate, forming metakaolin. This operation is performed by transporting the powdered products with hot gas whose temperature (500 to 850° C.) is precisely defined so as, on the one hand, to permit sufficient progress of the reaction (temperature and transport time) and, on the other hand, not to form crystallised products that are stable in the presence of lime (upper limit of the temperature).

The mechanical action envisaged according to the invention is preferably an action suitable for separating the particles constituting the mineral material of the base paste, in order to provide the dry material with its “natural” particle size distribution. This is why the term disaggregation is used here. Likewise, when it is used in the present description, the term grinding comprises any “gentle” type of action, in particular such as attrition, and is not limited to an operation suitable for reducing the particle size of a material by breaking up its constituent particles.

The temperature of the hot gas used in the disaggregation step is chosen to be less than 800° C., in order to avoid subsequent conversion of metakaolin into an unreactive form, but it is desirably as high as possible for rapid drying of the hydrated base paste. The temperature may be chosen within the range dependent on the water content and the inherent characteristics of the primary material, which are associated with its composition and therefore the quarry or source which is used. The precise temperature at which a kaolin is converted into metakaolin can be determined by subjecting the primary material to differential thermal analysis (DTA), the metakaolin transformation peak generally lying between 500 and 550 or 600° C. The temperature of the hot gas may advantageously be chosen to be of the order of 600 to 750° C., in particular 650 to 700°. This refers to the temperature of the gases after mixing and introduction of the argillaceous particles. It is therefore beneficial for the hot gas to be supplied at a temperature as close as possible to the transformation temperature, although this temperature should be as high as possible (850-900° C.) while being below the threshold corresponding to the reaction for conversion into mullite.

The conditions of the disaggregation step according to the invention permit substantial removal of the water present in the hydrated base paste. Typically, starting with a base paste having a water content of less than 30% by weight, in particular of the order of from 15 to 30% by weight, the disaggregated dry powder generally has a residual water content of the order of from 0 to 1% by weight.

Advantageously, the disaggregation is carried out by forcing the fragments of paste and the hot gas between grinding components. This produces a maximum surface area for contact between the paste and the hot gas, which promotes the exchange of heat and permits almost immediate drying.

By virtue of these drying conditions, the material of the base paste is reduced into a powder having the dimensions of its constituent particles. In general, the dry powder has a particle size of less than or equal to 100 μm, preferably less than or equal to 80 μm. It advantageously comprises at least 60% by weight of particles with a dimension of less than 20 μm, and preferably a small quantity (for example less than or equal to 5%) of particles with dimensions greater than 40 microns.

According to the primary material which is used, in particular when it is a natural material such as clay, the disaggregation step is followed by a step of separating coarse particles such as sand, in particular using a cyclone, after which the dry powder intended to undergo the heat treatment is recovered.

According to the primary material which is used, a dry powder containing aluminium silicate that may be partially dehydroxylated during the grinding-drying operation can be obtained. The degree of dehydroxylation can be assessed by the reactivity in the “Chapelle” test, which consists in evaluating the quantity of CaO potentially consumable by the mineral material, hence defining the pouzzolanic reactivity of the mineral addition. In this test, which is described by R. Largent in Bulletin de Liaison des Laboratoires des Ponts et Chaussées [journal of the laboratories of the French higher educational institute for civil engineering] No.93 (January-February 1978), 63-64, the mineral material and lime suspended in air are placed in contact for sixteen hours at close to the boiling point. After cooling, the amount of lime that has not reacted is determined. The result is expressed in g per 1 g of mineral material.

In order to achieve a high degree of dehydroxylation with a Chapelle test reactivity of at least about 0.7 to 0.8, the invention provides a step of heat treatment by transporting the dry powder in a hot gas stream at a temperature of from 600 to 850° C., for a time which is sufficient to achieve the desired degree of dehydroxylation, without the temperature of the particle reaching the zone for mineral conversion into mullite.

Analysis of the curves provided by DTA makes it possible to identify and quantify precisely both the reaction temperatures (determination of the minimum and maximum temperatures) and the kinetics of kaolin conversion into metakaolin, which is useful for determining according to the invention the pairing of temperature_transport time of the kaolin in powder form. The temperature of the hot gas determines (by using the DTA results) the time of transport (contact between the gas and the powder) which is necessary for converting the kaolin into metakaolin. For instance, in the case of a kaolin which was studied, the transport time needed to achieve 80% dehydroxylation is 13 seconds with a temperature of 600° C., whereas it is advantageously reduced to 0.1 s with gases at about 800° C. It is noteworthy that the heat treatment conditions of the elementary kaolin particles when placed in a dilute flow are substantially different from those which are produced in measuring instruments of the DTA/GTA type, where the sample is placed in a small packet. This geometrical arrangement is also modified by the presence of a relative humidity in the crucibles of the equipment which is greater than that prevailing in the dilute flow.

The powder which is to be subjected to the hot treatment may be treated directly after the disaggregation, if the latter is carried out on the site of the heat treatment, or alternatively after a step of intermediate storage on site or in a separate installation for preparation of the powder.

In the former case, it is possible to recover the powder with the hot gas stream when it leaves the disaggregation, then to transport the powder through the rest of the hot treatment, with optional supply of additional heat in the form of an auxiliary hot gas stream or other heating means, in order to raise the gas to a temperature of from 600 to 850° C.

In the latter case, the powder is introduced into a second hot gas stream at a temperature of from 600 to 850° C.

In either variant, the temperature of the hot gas may advantageously be controlled during the transport of the dry powder. The control may consist in imposing a temperature gradient on the gas and the powder, or, conversely, in keeping the temperature of the hot gas constant during the transport of the dry powder.

At the end of treatment, the dehydroxylated dry powder may be recovered by various means, in particular by filtration.

The invention also relates to an installation for the dehydroxylation treatment of aluminium silicate, characterised in that it includes a conduit supplied with a hot gas stream at a temperature of from 600 to 850° C., means for introducing a dry powder containing aluminium silicate into the conduit, and means for transporting the dry powder in this conduit.

According to other characteristics:

the installation comprises means for comminuting a hydrated base paste containing aluminium silicate into fragments, a grinder-dryer which disaggregates the fragments of base paste by mechanical action in the presence of a hot gas at a temperature of from 500° C. to 800° C., and means for collecting a dry powder downstream of the grinder-dryer;

the grinder-dryer includes a grinding zone with grinding components and passages for the hot gas in the said grinding zone;

the grinding components comprise at least two parallel discs carrying fingers projecting on their opposing surfaces, and in that the passages for the hot gas are the spaces between the fingers of the discs;

the installation comprises separation means, such as a cyclone, at the outlet of the grinder-dryer;

the installation comprises means for intermediate storage between the grinder-dryer and the conduit;

the conduit is supplied with hot gas by a burner whose flame is contained outside the conduit;

the conduit is equipped with external heating means, such as electrical heating elements and/or a heating jacket;

the heating means consist of at least one intake for a gas which, by combustion at a wall of the installation, makes it possible to maintain a wall temperature of close to 800° C.

the installation comprises, downstream, means for collecting powder by filtration.

Other details and characteristics of the invention will emerge from the following detailed description of an exemplary embodiment of the invention, which is provided with reference to the appended drawings, in which:

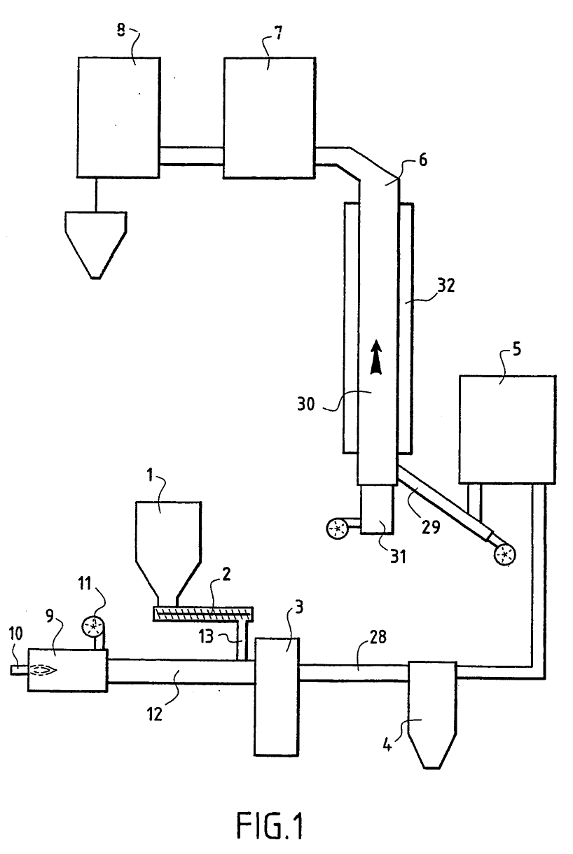

FIG. 1 represents a diagram of an installation according to the invention;

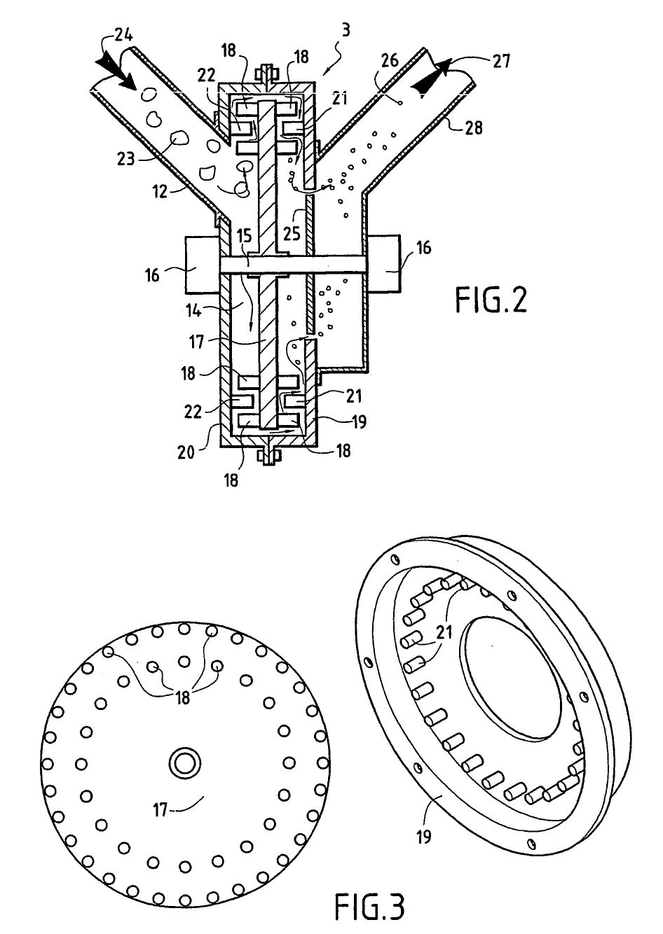

FIG. 2 represents a schematic sectional view of a grinder-dryer suitable for forming part of the installation in FIG. 1;

FIG. 3 presents in detail the grinding components of the grinder-dryer in FIG. 2.

In this example, the process according to the invention is used to treat kaolin clay, in order to convert aluminium sulphate into metakaolin.

To that end, the installation in FIG. 1 may be used. It should be pointed out that the representation in FIG. 1 is schematic, that the elements are not represented to scale, and that it does not limit the invention in any way, in particular as regards the arrangement of the various stations or the disposition or the orientation of the lines for circulating the materials.

This installation essentially comprises a clay storage hopper 1, a comminuter 2, a grinder-dryer 3, optionally a separation cyclone 4, optionally a storage container 5, a transport conduit 6, a cooling station 7 and a powder collection filter 8.

The clay contained in the hopper 1 is in the form as it is produced when extracted from the quarry, generally in the form of blocks of a hydrated base paste whose dimensions may be as much as about ten centimetres. In the initial state, it has a water content which may range, for example, from 15 to 30% by weight.

The comminuter 2 delivers fragments of base paste with reduced dimensions, in particular of the order of several centimetres, into the grinder-dryer 3, for example by means of a feed screw.

The grinder-dryer 3 is supplied with a hot gas stream produced at 9 by a burner 10 and a fan 11, the stream being transported to the grinder-dryer through a conduit 12. The flame of the burner 10 is regulated so that the temperature of the hot gas stream in the conduit 12 is of the order of from 500 to 800° C., preferably of the order of from 600 to 750° C., and in particular of the order of from 650 to 700° C.

The fragments of base paste are introduced into the hot gas stream at 13 with a rate which is controlled, for example, by the rotation of the screw, just before the conduit 12 meets the grinder-dryer 3.

The disaggregation step will be understood more clearly with reference to FIGS. 2 and 3, which respectively represent a type of grinder-dryer that can be used according to the invention, seen in section on a vertical plane in the axis of the line of the part of the installation represented at the bottom in FIG. 1, and a detail of this grinder-dryer seen in exploded perspective. This type of grinder-dryer is marketed, in particular, by CMI-HANREZ.

The grinder is essentially composed of an enclosed space 14, with a shaft 15 turning inside, which is driven by schematically indicated means 16 and which carries at least one disc 17 provided with at least one series of fingers 18 that project on at least one plane face of the disc and are preferably arranged in a ring around the periphery of the disc 17. The enclosed space includes two disc-shaped walls 19, 20 which are parallel to the disc 17 and which, on their surface opposing the plane faces of the disc 17, carry at least one series of fingers 21, 22 that are arranged in a ring around the periphery of the discs 19, 20. The series of discs are arranged concentrically, and their length is chosen so as to form chicanes between the fingers of two neighbouring series.

During operation, the rotation of the disc 17 drives the fragments 23 of base paste towards the periphery of the enclosed space 14. On the first face of the disc 17, the fragments pass through the chicanes formed between the fingers 18 and 22, then they pass along the periphery of the enclosed space 14 towards the other face of the disc 17 and, on the other face of the latter, they pass through the chicanes formed between the fingers 18 and 21. The effect of this path between the grinding fingers, which are very close together, is to knead or triturate the clay paste.

The hot gas stream 24 follows the same path, which is indicated by the arrows, and it envelops and penetrates the fragments of base paste, with a considerable surface area for exchange between the hot gas and the paste. This large exchange surface area permits very rapid, almost immediate evaporation of the water of hydration of the clay, which is progressively separated by attrition into particles of smaller and smaller size.

In the disc-shaped wall 19, a diaphragm 25 is arranged which permits the particles of small size to leave the enclosed space 14, whereas particles with larger dimensions are returned towards the chicanes in order to continue the disaggregation by attrition. It is therefore possible to regulate the device in order to recover, downstream of the diaphragm 25, a powder 26 whose particle size distribution is the natural particle size of the clay platelets. Typically, the powder 26 has dimensions of less than 100 μm, and it may even comprise at least 95% of particles with a dimension of less than 40 μm.

At this stage, the powder generally no longer contains more than from 0 to 1% by weight of water. It has a lime reactivity, according to the Chapelle test, which is substantially unchanged in relation to the initial stage, generally less than 0.5 g per 1 g.

The powder 26 and the gas stream 27, which has been cooled during the disaggregation operation (its temperature may fall to 100° C., but needs to be kept above its dew point) are recovered via a conduit 28, which may be directed towards a cyclone for optionally separating the particles of the powder as a function of their size, for example in order to remove grains of sand or the aggregated particles with a dimension of more than 100 or 40 microns.

The powder 26 transported by the gas stream 27 may be stored at 5, after discharge of the transport gas, or may be sent directly to the heat treatment stage which follows.

In FIG. 1, the powder is taken from the silo 5 and conveyed via a conduit 29, for example in a carrier gas stream, towards the transport conduit 6 in which a gas stream 30 produced by a burner 31 circulates, the said burner being located upstream of the conduit 6 so that the flame of the burner cannot extend into the zone where the powder is introduced. The flame of the burner 31 is regulated so that the temperature of the hot gas stream 30 in the conduit 6 is of the order of from 600 to 850° C., preferably of the order of from 600 to 800° C. The hot gas may be a combustion gas, as is the case here, but it could also be any other type of gas, air or the like, which is heated by any known means.

In order to disturb the thermal equilibrium in the conduit as little as possible, the powder may be conveyed into the conduit 29 by a hot gas stream.

The conduit 6 may be equipped with means for control and regulation of the temperature of the gases, for example in order to impose a temperature gradient along the conduit or, conversely, to keep the temperature within a small variation range. The conduit 6 will advantageously be provided with heating means, because the kaolin dehydroxylation reaction is endothermic and lowers the temperature of the treatment gas, and therefore that of the particles.

Hence, the conduit represented in FIG. 1 is equipped with a heating jacket 32, which may consist of a double sleeve inside which a heating fluid circulates, in particular combustion gases. As a variant or in addition, electrical heating means may be provided.

Since the dehydroxylation reaction is endothermic, it may be beneficial in terms of thermal efficiency to provide an energy input into the particles transported in the flow. This energy input may be provided, in particular, by electrical radiation or by gaseous or liquid combustion of a fuel. (If a gas is used, it will spontaneously ignite in contact with the wall.)

The conduit is advantageously provided with external insulation (not shown) to counteract heat losses.

The conduit 6 is arranged in any known way that permits fluidisation of the powder particles, preferably vertically, and it is dimensioned so as to permit a sufficient residence type of the powder with the gas stream 30. This dimensioning depends, inter alia, on the material which is being treated, the particle size of which dictates the fluidisation rate, which is the minimum speed of the gas stream 30 for transporting the powder throughout the conduit. As an illustration, the speed of the gas 30 for treating clay may be of the order of 10 m/s.

The residence time of the powder in the conduit actually depends on the desired degree of dehydroxylation and the temperature of the gas 30, and it will therefore be adapted on a case-by-case basis by the person skilled in the art. A residence time of from 0.1 to 0.2 s at 800° C. is generally sufficient in order to increase the Chapelle test reactivity significantly, advantageously by at least 0.1 g, and in particular by of the order of from 0.7 g to 0.8 g.

On the basis of a kaolin clay which, when leaving the grinder-dryer, already had a capacity to bind lime according to the Chapelle test with a reactivity, for example, of the order of 0.5 g, it was possible to verify that the treatment in the conduit 6 permits the dehydroxylation to be enhanced, increasing the reactivity of the powder. The treatment in the conduit 6 may also be used to impart reactivity to a material which is initially very unreactive.

Therefore, in another test, a kaolin powder marketed by the company SOKA under the brand name SIALITE, whose initial Chapelle reactivity is very low (of the order of 45 mg of CaO per gram), was treated using a gas at 800° C. forced with a speed of 10 m/s through a 1.7 m long conduit, the degree of dehydroxylation being such that the Chapelle reactivity was 307 mg per 1 gram of material and, for a 5.1 m long conduit, a reactivity of 0.7 per 1 gram of dry material was achieved.

When leaving the conduit, the powder 26 and the gas 30 are still at an elevated temperature, and it may be desirable to cool them before proceeding with the separation of the powder. This is why the installation comprises a heat exchanger 7 connected to the outlet of the conduit 6, upstream of the filter 8 for separating the dehydroxylated powder.

A hot gas recycling circuit, with the possibility of re-heating, may be provided in order to improve the thermal or energy efficiency of the installation.

Although it has been described more particularly with reference to the treatment of a kaolin clay, the invention is generally applicable to the treatment of any material containing aluminium silicate.

1. Process for dehydroxylation treatment of aluminium silicate, in which particles containing aluminium silicate are exposed to a temperature of at least 500° C., characterised in that the particles are in the form of a dry powder, and in that the dry powder (26) is transported in a gas stream (30) at a temperature of from 600 to 850° C., for a time which is sufficient to achieve the desired degree of dehydroxylation.

2. Process according to claim 1, characterised in that the powder is formed from a hydrated base paste containing aluminium silicate, in the following way:
the base paste is reduced into fragments (23),
the fragments (23) of base paste are disaggregated by mechanical action (at 3) in the presence of a hot gas (24) at a temperature of from 500° C. to 800° C., in order to form the dry powder (26).

3. Process according to claim 2, characterised in that the base paste has a water content of less than 30% by weight, and in that the dry powder has a residual water content of the order of from 0 to 1% by weight.

4. Process according to any one of the preceding claims, characterised in that the dry powder has a particle size of less than or equal to 100 μm, preferably less than or equal to 80 μm.

5. Process according to any one of claims 2 to 4, characterised in that the disaggregation is carried out by forcing the fragments (23) of paste and the hot gas (24) between grinding components (18, 21, 22).

6. Process according to any one of claims 2 to 5, characterised in that the disaggregation step is followed by a step of separating coarse particles (at 4), after which the dry powder is recovered.

7. Process according to any one of the preceding claims, characterised in that the dry powder is stored (at 5) before transporting it (at 6) in the hot gas stream.

8. Process according to any one of the preceding claims, characterised in that the temperature of the hot gas is controlled during the transport of the dry powder.

9. Process according to claim 8, characterised in that the temperature of the hot gas is kept substantially constant during the transport of the dry powder.

10. Process according to any one of the preceding claims, characterised in that the dehydroxylated dry powder is recovered by filtration after cooling.

11. Process according to any one of the preceding claims, characterised in that the treated dry powder has a Chapelle reactivity of at least 0.7 g per 1 gram.

12. Installation for the dehydroxylation treatment of aluminium silicate, characterised in that it includes a conduit (6) supplied with a hot gas stream (30) at a temperature of from 600 to 850° C., means for introducing a dry powder containing aluminium silicate into the conduit (6), and means (31) for transporting the dry powder in this conduit.

13. Installation according to claim 12, characterised in that it comprises means (2) for comminuting a hydrated base paste containing aluminium silicate into fragments (23), a grinder-dryer (3) which disaggregates the fragments (23) of base paste by mechanical action in the presence of a hot gas (24) at a temperature of from 500° C. to 800° C., and means (28, 8) for collecting a dry powder (26) downstream of the grinder-dryer.

14. Installation according to claim 13, characterised in that the grinder-dryer (2) includes a grinding zone with grinding components (18, 21, 22) and passages for the hot gas in the said grinding zone.

15. Installation according to claim 14, characterised in that the grinding components comprise at least two parallel discs (17, 19, 20) carrying fingers (18, 21, 22) projecting on their opposing surfaces, and in that the passages for the hot gas are the spaces between the fingers (18, 21, 22) of the discs.

16. Installation according to one of claims 12 to 15, characterised in that it comprises separation means (4), such as a cyclone, at the outlet of the grinder-dryer (3).

17. Installation according to one of claims 12 to 16, characterised in that it comprises means (5) for intermediate storage between the grinder-dryer (3) and the conduit (6).

18. Installation according to one of claims 12 to 17, characterised in that the conduit (6) is supplied with hot gas (30) by a burner (31) whose flame is contained outside the conduit.

19. Installation according to one of claims 12 to 17, characterised in that the conduit (6) is equipped with external heating means, such as electrical heating elements and/or a heating jacket (32).

20. Installation according to one of claims 12 to 18, characterised in that it comprises, downstream, means for collecting powder by filtration (8).

21. Installation according to claim 19, characterised in that the external heating means are constituted by electrical radiation or by gaseous or liquid combustion of a fuel.
